(19) United States
(12) Patent Application Publication
(10) Pub. No.: US 2024/0198876 A1
(43) Pub. Date: Jun. 20, 2024

(54) VEHICLE SEAT WITH SIMULTANEOUS ADJUSTMENT OF SEAT DEPTH AND LUMBAR SUPPORT

(71) Applicant: GRAMMER Aktiengesellschaft, Ursensollen (DE)

(72) Inventors: Thomas PÖLLINGER, Regensburg (DE); Christopher NEIDL, Schmidgaden (DE); Sebastian WEGMANN, Regensburg (DE)

(73) Assignee: GRAMMER Aktiengesellschaft, Ursensollen (DE)

(21) Appl. No.: 18/502,850

(22) Filed: Nov. 6, 2023

(30) Foreign Application Priority Data
Dec. 15, 2022 (DE) 10 2022 133 443.0

(51) Int. Cl. B60N 2/66; B60N 2/02

(52) U.S. Cl. CPC B60N 2/666; B60N 2/0284

(57) ABSTRACT

The invention relates to a vehicle seat for simultaneous adjustment of a seat depth and a lumbar support of the vehicle seat, wherein the vehicle seat comprises a backrest frame, a seat part frame and a connecting frame, wherein the connecting frame is rotatably connected about a first rotation axis to the backrest frame and rotatably connected about a second rotation axis to the seat part frame and connects the seat part frame to the backrest frame, wherein the seat part frame and the backrest frame are connected to a supporting element such that the seat part frame and the backrest frame are simultaneously displaceable relative to the supporting element.

### CROSS REFERENCE TO RELATED APPLICATION

This application claims the benefit of German Patent Application No. 10 2022 133. 443.0, filed Dec. 15, 2022, the contents of which are incorporated herein by reference in its entirety.

### FIELD

The present patent application relates to a vehicle seat for simultaneous adjustment of a seat depth and a lumbar support of the vehicle seat.

### BACKGROUND

DE 10 2014 118 061 A1 is known from the prior art, for example, which shows a seat depth adjustment and a simultaneous lumbar or kyphotic support of the lower back.

Thereby the vehicle seat has a seat part which has a bracket element arranged in the rear section which, when the seat part is pushed forward, it deforms a spring sheet metal elements and thus adjusts the support of the lumbar section to the back of a person sitting on it.

Due to the provision of spring sheet metal elements, the vehicle seat shown according to the prior art has the disadvantage that the seat part tends to be displaced backwards again, since the spring sheet metal elements are elastically deformed. Likewise, a structurally complex form of the vehicle seat is provided.

### SUMMARY

It is therefore the object of the present application to specify a vehicle seat for simultaneous adjustment of a seat depth and a lumbar support, which is of particularly simple formed and overcomes the disadvantages of the prior art.

The underlying object is solved by a vehicle seat with the features of claim 1.

According to the invention, it is a core idea of the present application to provide a vehicle seat for simultaneous adjustment of a seat depth and a lumbar support of the vehicle seat. According to the invention, it is provided that the vehicle seat comprises a backrest frame, a seat part frame and a connecting frame, wherein the connecting frame is rotatably connected about a first rotation axis to the backrest frame rotatably connected about a second rotation axis to the seat part frame. It is further provided that the connecting frame connects the seat part frame to the backrest frame, wherein it is further provided that the seat part frame and the backrest frame are connected to a supporting element such that the seat part frame and the backrest frame are simultaneously displaceable relative to the supporting element.

If a person who is able to sit on the vehicle seat wishes to adjust the seat depth, the person can manually displace the seat section either forward or backward until the correct seat depth is set for that person.

When a seat depth is adjusted, it is provided in accordance with the invention that the backrest frame is also displaced with respect to the supporting element along with the seat part frame. Accordingly, the connecting frame, which is arranged between the backrest frame and the seat part frame, namely is rotatably arranged, is also displaced accordingly with the seat part frame and pulls the backrest frame accordingly when the seat part frame is displaced.

Due to the compulsory guidance of the connecting frame with respect to the seat part frame and the backrest frame, the position or the arrangement of the connecting frame in space changes, namely to the effect that a lower section of the connecting frame displaced forward or backward correspondingly with the seat part frame.

The changing of the position of the connecting frame in space, as shown previously, this changes the lumbar support of the vehicle seat.

The connecting frame may therefore also be referred to as a lumbar support frame, which is formed and arranged in such a way that the connecting frame may provide support for the lumbar section of a person.

By the specified supporting element it may be understood, for example, that it may be a rigid seat shell which is configured such that the seat part frame and the backrest frame may be attached thereto, namely in such a way that a displacement of the seat part frame and the backrest frame with respect to the supporting element is possible.

Particularly preferably, the supporting element is arranged stationary, that is, in particular stationary with respect to a cabin or a carriage.

According to a particularly preferred embodiment, it is provided that the connection of the seat part frame and the backrest frame to the supporting element is such that the backrest frame and the seat part frame can each be displaced exclusively in translationally with respect to the supporting element.

This means that when the seat part frame is displaced forwards or backwards, the backrest frame can be moved upwards or downwards accordingly. The translational displacement of the seat part frame and the backrest frame therefore provides and realizes a compulsory guidance of the connecting frame.

Hereby, a particularly compulsory guidance of the connecting frame can be achieved in order to precisely and as easily as possible adjust the lumbar support of the vehicle seat.

According to a further preferred embodiment, it can be provided that the seat part frame and the backrest frame include a fixed and unchangeable angle to one another. This may advantageously allow the angle of the person between the upper section of the back and the buttocks to remain unchanged, so that a further particularly advantageous adjustment is possible in the lumbar section of the back.

According to a further particularly preferred embodiment, it may be provided that a first variable angle is provided between the seat part frame and the connecting frame and a second variable angle is provided between the backrest frame and the connecting frame.

Further preferably, it is provided that the size of the variable angles change when the seat part frame is displaced, whereby the lumbar support or the adjustment of the lumbar support is changeable.

This makes it possible for the arrangement of the connecting frame to the seat part frame and the backrest frame to provide a good adjustment of the lumbar and the lumbar support, respectively.

According to a further preferred embodiment, it may be provided that the backrest frame and the seat part frame are each translationally displaceable by means of guiding means. Further preferably, it can be provided that the guiding means can be at least one sliding block guide.

For the case that the guiding means is a sliding block guide, it is particularly advantageously provided that sliding block elements and slots are provided. Particularly advantageously, the sliding block elements are connected to the supporting element and the slots are integrated into the seat part frame and the backrest frame. This has the particular advantage that the corresponding frames can be hooked in during assembly of the vehicle seat.

Particularly advantageously, it is provided that the sliding block elements are formed at least partially complementary to the slots, so that the sliding block elements can be guided in the slots.

The guiding means can be formed in a particularly simple and structurally advantageous manner if one of the sliding block elements or each sliding block element comprises a first section, a second section and a third section, wherein the first section is arranged above the slot and is formed wider than the slot, and wherein the second section is arranged to the first section and extends through the corresponding slot and a third section is arranged below the slot and is arranged to the second section, wherein the third section is also formed wider than the slot.

The sliding block element thus preferably has a layered structure formed by the first section, the second section and the third section, which are arranged one above the other in a height direction. By the fact that preferably the second section can be guided in the slot and the first section and the third section are formed wider than the slot, a release of the sliding block and the slot can be prevented.

Particularly preferably, the slot or the slots have a assembly section which is formed and provided for the first section that is guided through this assembly section so that the second section can then be guided through the slot. Preferably, the assembly section is dimensioned in such a way that the first section can be guided therethrough.

The slot is held by the first section and the third section, so that the sliding block can be well prevented from falling out of the slot.

Particularly preferably, the position of the assembly section or the displacement of the seat part is such that in an assembled state of the vehicle seat, which means that the seat part is assembled on the seat part frame, the sliding block cannot be guided all the way into the assembly section in order to be able to prevent the sliding block from falling out of the slot.

According to a further preferred embodiment, it may be provided that the backrest frame and the connecting frame are connected to a first upholstery element and the seat part frame is connected to a second upholstery element. Particularly preferably, it is provided that the first upholstery element is independent of the second upholstery element. This means that the first upholstery element and the second upholstery element are separate elements and are not connected to each other.

By the fact that the upholstery elements are independent of each other, this means that a deformation of the upholstery element can be reduced by the displacement of the seat part frame and the corresponding displacement of the backrest frame and the connecting frame, so that the durability and usability of the upholstery elements can be increased overall. Likewise, the first upholstery element in particular can better adapt to the conditions and position of the connecting frame.

Likewise, the independence of the upholstery elements can facilitate the assembly of the vehicle seat, since the seat part with the seat part frame can be assembled independently from the backrest frame, and a connection can then be easily established during assembly by means of the connection between the seat part frame and the connecting frame.

According to a further preferred embodiment, it may be provided that for improved assembly there is a releasable connection between the seat part frame and the connecting frame. Further preferably, the releasable connection is preferably a clip connection.

Particularly preferably according to a further preferred embodiment, it may be provided that the releasable connection comprises a sleeve element and a shaft piece insertable into the sleeve element. Preferably, the sleeve element can be formed such that in a cross-section the sleeve element represents a circular sector with a center angle of more than 180° and at most 300°. Further preferably, it may be provided that the shaft piece is formed at least partially complementary to the sleeve element and may be inserted into the sleeve element.

At least partially complementary here refers in particular to an inner section of the sleeve element. In particular, the sleeve element has an outer and an inner boundary, wherein the inner boundary forming the interior of the sleeve element.

Particularly preferably, the sleeve element is formed of an elastically deformable material, so that the shaft piece can be easily inserted into the sleeve element, since the shaft piece is formed complementarily to the interior of the sleeve element and therefore the opening of the sleeve element must be slightly widened in order to be able to clip the shaft piece into the sleeve element.

Further configurations and forms in the embodiments among each other are applicable to the further embodiments and are freely combinable among each other, provided that they do not correspond to opposite embodiments.

Further advantageous embodiments result from the subclaims.

Further objectives, advantages and usefulness of the present invention will be found in the following description in connection with the drawings.

The invention is illustrated in more detail below in connection with the figures.

### BRIEF DESCRIPTION OF THE DRAWINGS

The figures show:

FIG. 1A Vehicle seat according to one embodiment in a basic position;

FIG. 1B Vehicle seat of FIG. 1A in a displaced position;

FIG. 1C Vehicle seat of FIG. 1A with upholstery elements;

FIG. 1D Vehicle seat according to FIG. 1C in a side view;

FIG. 2A Vehicle seat according to FIG. 1D in the basic position;

FIG. 2B Vehicle seat according to FIG. 2A in a sectional view;

FIG. 3A Vehicle seat according to FIG. 1D in a first displaced position;

FIG. 3B Vehicle seat according to FIG. 3A in a sectional view;

FIG. 4A Vehicle seat according to FIG. 1D in a second displaced position;

FIG. 4B Vehicle seat according to FIG. 4A in a sectional view;

FIG. 5A Vehicle seat according to FIG. 1D in a third displaced position;

FIG. 5B Vehicle seat according to FIG. 5A in a sectional view;

FIG. 6A Vehicle seat according to FIG. 1D in a fourth displaced position;

FIG. 6B Vehicle seat according to FIG. 6A in a sectional view;

FIG. 7A Vehicle seat according to FIG. 1D in a maximum displaced position;

FIG. 7B Vehicle seat according to FIG. 7A in a sectional view;

FIG. 8A Guiding means according to one embodiment;

FIG. 8B Guiding means according to a further embodiment with respect to a seat part frame;

FIG. 8C Connection between a backrest frame and a connecting frame according to one embodiment; and

FIG. 8D Connection between a seat part frame and a connecting frame according to one embodiment.

### DETAILED DESCRIPTION

In the figures, identical components are to be understood with the corresponding reference signs in each case. For the sake of clarity, components may not have a reference sign in some figures but have been designated elsewhere.

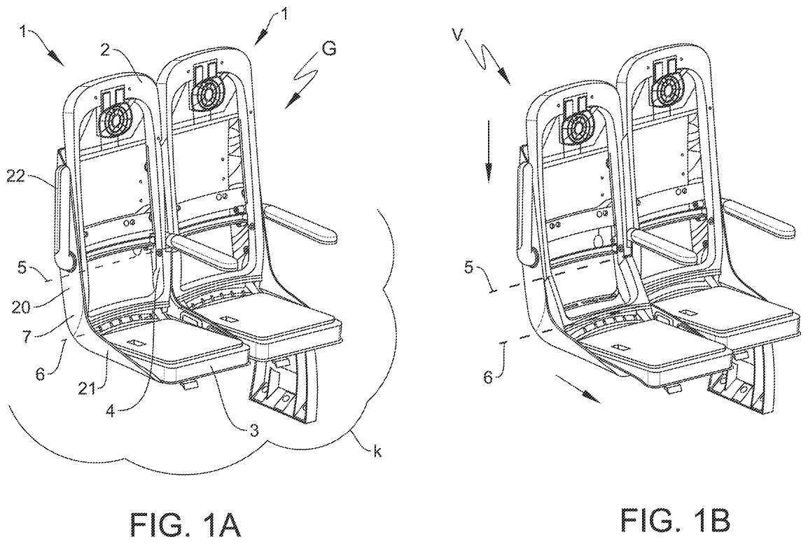

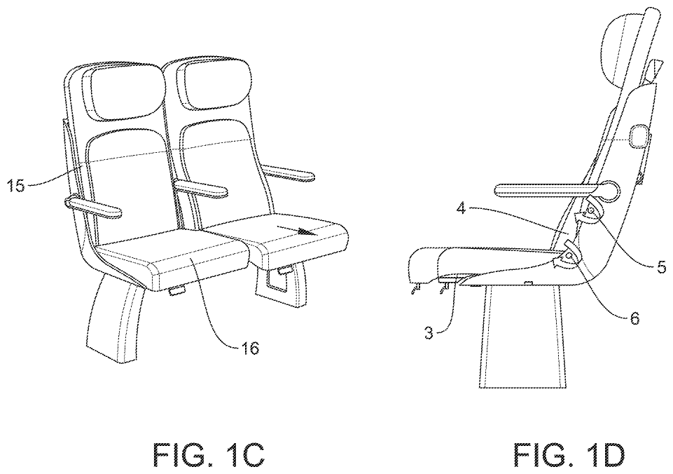

FIG. 1A shows two vehicle seats 1 arranged side by side. The following explanations and declarations apply with respect to each of the vehicle seats 1.

As can be seen, the vehicle seat 1 comprises a backrest frame 2, a seat part frame 3 and a connecting frame 4. Thus, the backrest frame 2 and the connecting frame 4 are rotatably connected to each other about a first rotation axis 5. Further, the connecting frame 4 is also rotatably connected to the seat part frame 3 about a second rotation axis 6.

Further, a supporting element 7 is shown which is stationary and rigidly connected thereto with respect to a vehicle or cabin K. The backrest frame 2, the seat part frame 3 and the connecting frame 4 are thereby connected to the supporting element 7. The connection between the frames 2, 3, 4 and the supporting element 7 is such that the frames 2, 3, 4 can be displaced relative to the supporting element 7.

Preferably, the supporting element 7 has a backrest section 20 and a seat section 21, wherein the backrest section is connectable to the backrest frame 2 and the seat section 21 is connectable to the seat section frame 3.

One or more armrests 22 can be arranged on the support element 7, in particular on the backrest section 20.

The vehicle seats 1 according to FIG. 1a are shown in a basic position G that means that the seat part is in its basic position, which means that it has not yet been displaced forwards. The position in which the seat part frame 3 is in its most rearward position is defined as the basic position G.

In FIG. 1B, one of the two vehicle seats 1 is now shown in a displaced position V, that means that the seat part 3 or the seat part frame 3 is displaced forward, represented by the corresponding arrow. By connecting the backrest frame, the seat part frame 3 and the connecting frame 4, in accordance with the forward displacement of the seat part frame 3, the backrest frame 2 is correspondingly moved downward, also shown by the corresponding arrow, and the connecting frame 4 is moved forward in the section of the second rotation axis 6 with the seat part frame 3 and downward in the section of the first rotation axis 5 with the backrest frame 2.

As can be clearly seen in FIG. 1B, the seat depth has been adjusted on the one hand by displacing the seat part frame 3 forwards and the lumbar support of the vehicle seat has also been adjusted by the compulsory guidance of the connecting frame 4.

In FIG. 1C, the vehicle seat according to FIGS. 1A and 1B respectively is shown again, wherein a first upholstery element 15 and a second upholstery element 16 can be seen, wherein the first upholstery element 15 is connected to the backrest frame 2 and the connecting frame 4. The second upholstery element 16 is connected to the seat part frame 3. In particular, the upholstery elements 15, 16 are independent of each other, that means that there is no functional connection between the two upholstery elements 15, 16. However, the upholstery elements 15, 16 can touch each other, but are independent of each other in movement and in formation.

In FIG. 1D, the vehicle seat 1 is shown in a side view, wherein the basic position G is shown on the one hand and on the other hand the displaced position V is shown. By comparing the two positions G, V, it is easy to see, on the one hand, how the seat depth of the seat part 3 or seat part frame 3 and, on the other hand, the lumbar support have been adjusted by means of the connecting frame 4.

It is also the case that the first rotation axis 5 is always arranged above the second rotation axis 6. In this case, the rotational axes 5, 6 are arranged in such a way that the section between the rotational axes 5, 6 corresponds to the lumbar section of a person. The same applies likewise to the connecting frame 4.

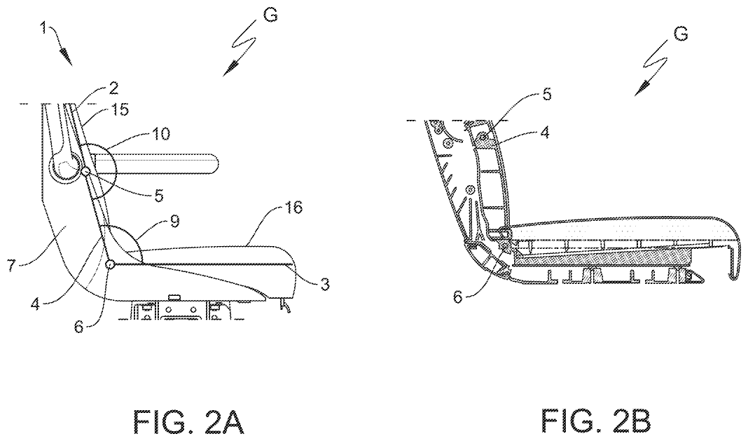

In the following FIGS. 2A to 7B, various positions of the vehicle seat are shown.

The respective FIGS. 2A to 7B are shown either in a side view or in a sectional view.

FIG. 2A shows the vehicle seat 1 in its basic position, that means that the seat part frame 3 or the seat part is arranged in its rearmost position. The seat part frame 3 and the backrest frame 2 can be displaced relative to the supporting element 7 exclusively in a translatory manner. This means in particular that the backrest frame 2 and the seat part frame can be moved in their direction of extension.

It is further provided that a fixed and unchangeable angle 8 is formed between the backrest frame 2 and the seat part frame 3. Further, a second changeable angle is formed between the backrest frame 2 and the connecting frame 4, and a first changeable angle is formed between the connecting frames 4 and the seat part frame 3. These variable angles 9, 10 change depending on the position of the seat part frame and accordingly of the backrest frame 2.

In FIG. 2B, the vehicle seat according to FIG. 2A is shown in a sectional view.

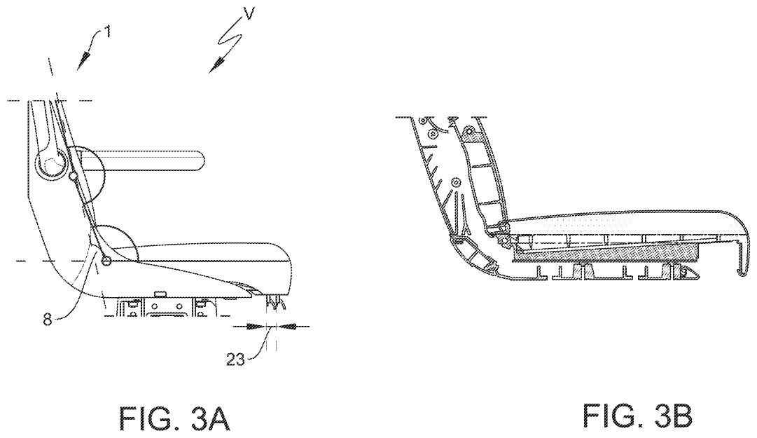

FIG. 3A shows a first displaced position of the vehicle seat 1, wherein the seat part frame 3 has been displaced forward by a first seat depth 23. Corresponding to the forward displacement of the seat part frame 3 by the same seat depth 23, the connecting frame 4 is displaced along with it and accordingly and accordingly the seat back frame 2 has also been displaced downward along the direction of extension of frame 2. As can be further seen, the sizes of the variable angles 9, 10 have changed.

Specifically, the angles 9, 10 change in such a way that when the seat is displaced forward by a seat depth 23, the first variable angle increases and the second variable angle decreases.

In FIG. 3B, the vehicle seat according to FIG. 3A is shown in a sectional view.

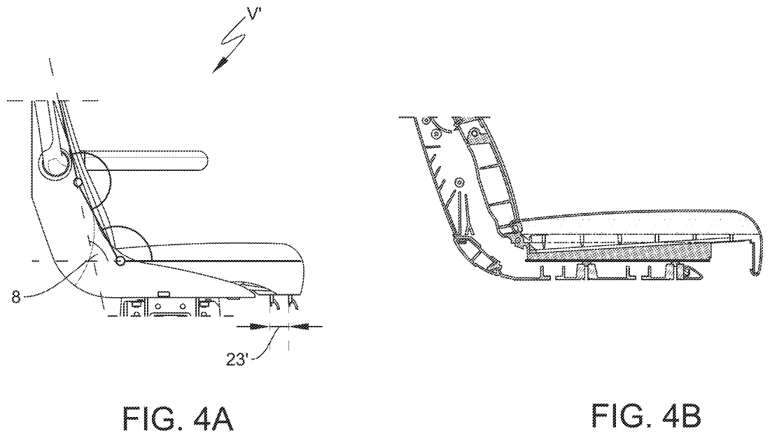

In FIG. 4A, the vehicle seat 1 is further shown in a second displaced position V′, wherein the seat part frame 3 or the seat part has been displaced forward by a seat depth 23′. The variable angles 9, 10 have further changed in such a way that the first variable angle has further increased and the second variable angle 10 has further decreased.

In FIG. 4B, the vehicle seat 1 according to FIG. 4A is again shown in a sectional view.

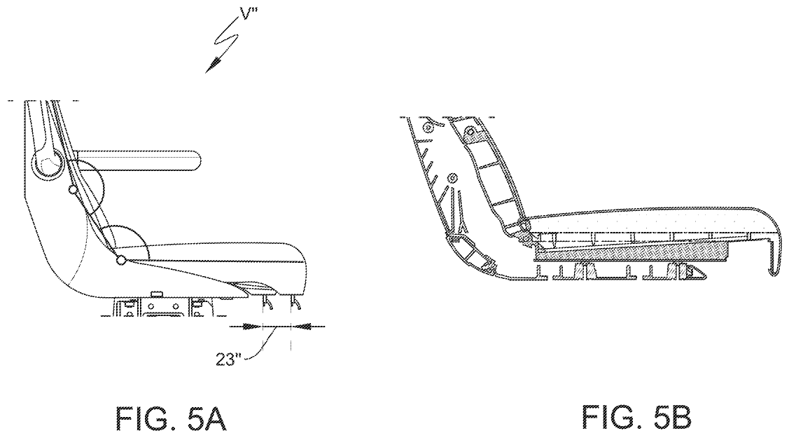

FIG. 5A further illustrates the situation in a third displaced position V″, wherein the seat section frame 3 or the seat section is displaced forward by a seat depth 23″. The first variable angle 9 has further increased and the second variable angle 10 has further decreased.

In FIG. 5B, the vehicle seat 1 according to FIG. 5A is shown in a sectional view.

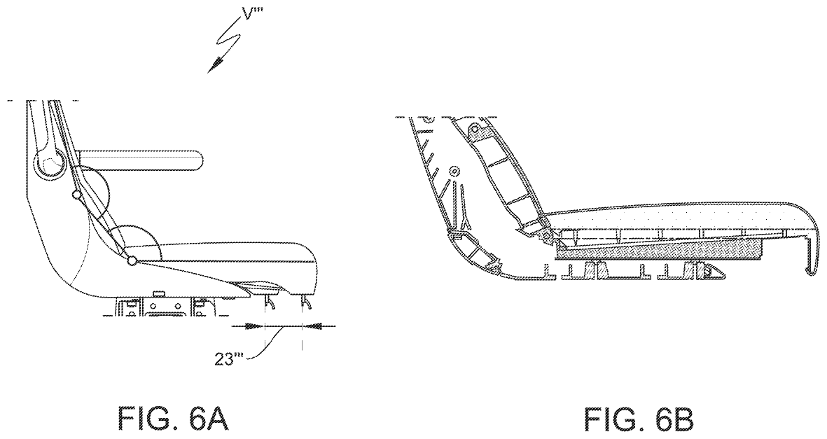

According to FIG. 6A, a fourth displaced position V″′ is shown, wherein the seat part frame 3 or the seat part has been displaced forward by a fourth seat depth 23″′. The angles 9, 10 behave accordingly.

In FIG. 6B a cross-section of the vehicle seat 1 according to FIG. 6A is shown.

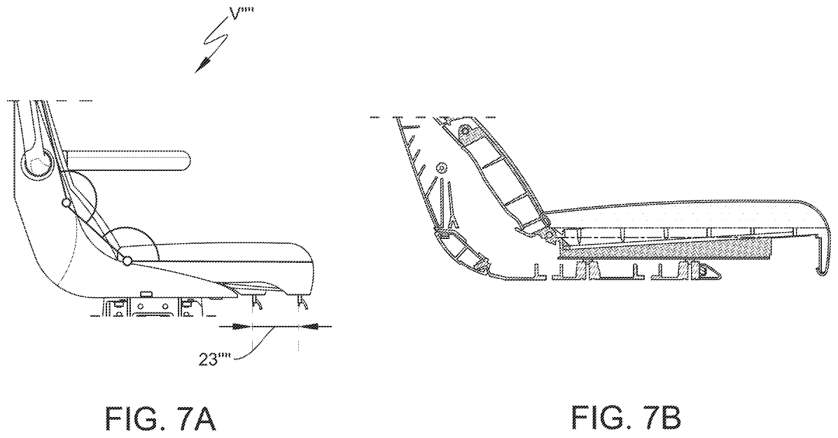

FIG. 7A shows a fifth displaced position V″″, wherein the seat part or the seat part frame 3 has been displaced forward by a seat depth 23″″. The fifth displaced position V″″ corresponds to a maximum displaced position.

FIG. 7B shows a cross-section of the vehicle seat 1 as shown in FIG. 7A.

By displacing the seat part frame 3 or the seat part forward by a seat depth 23, 23′, 23″, 23″′, 23″″, the connecting frame 4 can be adjusted with respect to its positioning relative to the backrest frame 2 and the seat part frame 3, wherein the position of the connecting frame 4 in space can be changed by the variable angles 9, 10. Accordingly, the inclination of the first upholstery element 15, which is assigned to the connecting frame 4 or the backrest frame 2, also changes, as shown in FIGS. 2A to 7B. Therefore allows the lumbar support of the vehicle seat 1 to can adjusted through this.

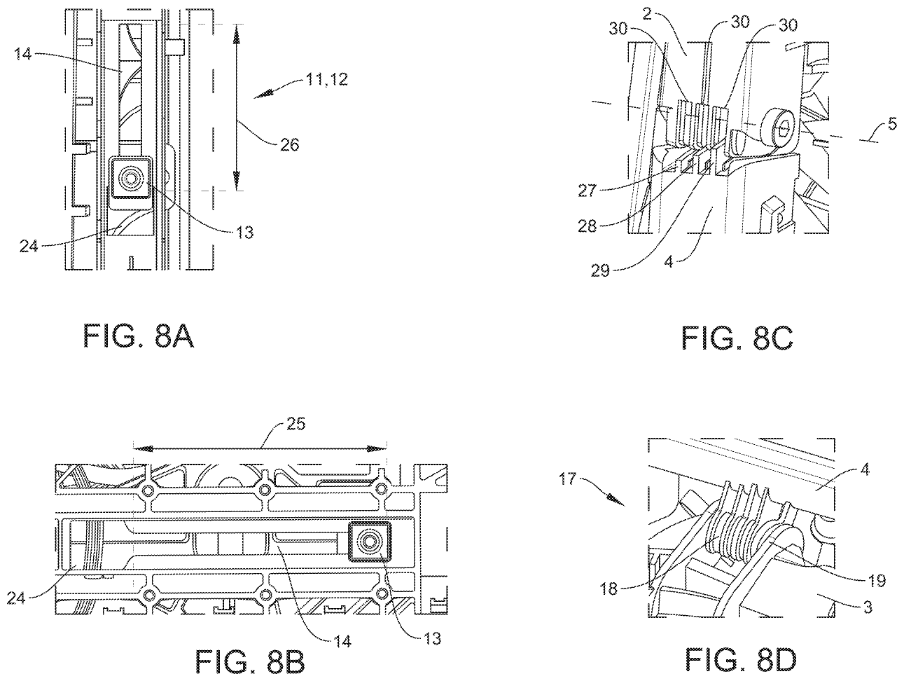

According to FIG. 8A, a guiding means 11 is shown, which is formed as a sliding block guide 12. The guiding means 11 of FIG. 8A refers to the guide of the backrest frame 2 relative to the supporting element 7.

The sliding block guide 12 comprises at least one sliding block element 13 and a slot 14, wherein the slot is formed and provided for guiding the sliding block element 13 therein.

Further preferably, the sliding block element 13 is connected to the support element 7, in particular to the backrest section 20 of the supporting element 7.

Further, the slot 14 has a assembly section 24 which is formed and provided such that the sliding block element 13 can be inserted into the slot 14.

FIG. 8B shows a guiding means 11 with respect to the seat part frame 3, wherein the guiding means 11 is also formed from a sliding block guide 12. The form of the sliding block elements 13 and the slot 14 with the assembly section 24 is identical to the guiding means 11 and the sliding block guide 12, respectively, with respect to the backrest frame 2.

According to FIG. 8B, it is further shown that the sliding block element 13 is in the foremost position of the slot 14, that is, that the seat part frame 3 is in the maximum displaced position. The forward displacement of the seat part frame 3 may be limited by this.

FIG. 8A shows the counterpart of the sliding block guide 12 with respect to the backrest frame 2, that is to say that the sliding block 13 is also shown according to the maximum displaced position. It is provided that in the maximum displaced position, the sliding blocks of the guiding means 11 of the backrest frame 2 cannot move as far as the assembly section 24, so that the sliding block can be prevented from falling out of the slot 14.

The same applies to the sliding blocks 13 in the basic position G, that means that the seat part frame 3 is arranged in its rearmost possible position. In this case, the sliding block 13 of the guiding means 11 of the backrest frame 2 is shown in its uppermost position, wherein the sliding block 13 for the guiding means 11 of the seat part frame 3 likewise cannot be displaced as far as the assembly section 24.

Hereby, a safety feature is implemented due to the lengths of the slots, which differ with respect to the backrest frame 2 compared to the seat part frame 3. In this case, a length 25 of the slot 14 with respect to the seat part frame 3 is longer than a length 26 of the slot with respect to the backrest frame 2. In particular, the lengths 25, 26 of the slots 14 are formed in such a way that the above-described effect of preventing falling out of the slot 14 is possible.

According to FIG. 8C, a connection between the backrest frame 2 and the connecting frame 4 is shown.

The connecting frame 4 has a first web element 27, a second web element 28 and a third web element 29, which extend into correspondingly formed acceptance 30 of the backrest frame 2. Preferably, it may preferably be provided that the first web element 27 has a smaller extension than the second web element 28, wherein further preferably the second web element 28 has a smaller extension than the third web element 29. By providing the web elements 27, 28, 29 projecting into the corresponding acceptance 30, improved guidance can be provided during a rotational movement of the connecting frame 4 with respect to the backrest frame 2.

According to FIG. 8D, a connection between the seat part frame 3 and the connecting frame 4 is further shown, wherein the connection is a releasable connection 17 and comprises a sleeve element 18 and a shaft piece 19. The sleeve element 18 is thereby arranged on the connecting frame 4 and the shaft piece 19 is arranged on the seat part frame 3. The releasable connection 17, with the sleeve element 18 and the shaft piece 19, is a clip connection, wherein the sleeve element 18 has a cross-section of a circular sector and the shaft piece is formed at least partially complementary to the sleeve element 18 and is insertable into the sleeve element 18.

All features disclosed in the application documents are claimed to be essential to the invention insofar as they are individually or in combination new compared to the prior art.

All the features listed may be combined with one another in any desired manner.

### LIST OF REFERENCE SIGNS

1 Vehicle seat
2 Backrest frame
3 Seat part frame
4 Connecting frame
5 First rotation axis
6 Second rotation axis
7 Supporting element
8 Fixed angle
9 First variable angle
10 Second variable angle
11 Guiding means
12 Sliding block guide
13 Sliding block element
14 Slot
15 First upholstery element
16 Second upholstery element
17 Detachable connection
18 Sleeve element
19 Shaft piece
Backrest section
21 Seat part section
22 Armrest
23, 23′, 23″, 23″′, 23″″ Seat depth
24 Assembly section
25 Length
26 Length
27 First web element
28 Second web element
29 Third web element
30 Acceptance
G Basic position
V, V′, V″, V″′, V″″ Displaced position
K Cabin

What is claimed is:

1. A vehicle seat for simultaneous adjustment of a seat depth (23, 23′, 23″, 23″′, 23″″) and a lumbar support of the vehicle seat,
wherein
the vehicle seat comprises a backrest frame, a seat part frame and a connecting frame, wherein the connecting frame is rotatably connected about a first rotation axis to the backrest frame and rotatably connected about a second rotation axis to the seat part frame and connects the seat part frame to the backrest frame, wherein the seat part frame and the backrest frame are connected to a supporting element in such a way that the seat part frame and the backrest frame are simultaneously displaceable relative to the supporting element.

2. The vehicle seat according to claim 1,
wherein
the seat part frame and the backrest frame include a fixed and unchangeable angle relative to one another.

3. The vehicle seat according to claim 1,
wherein
a first variable angle is provided between the seat part frame and the connecting frame and a second variable angle is provided between the backrest frame and the connecting frame, wherein the size of the variable angles changes as the seat part frame is displaced, wherein the lumbar support is variable.

4. The vehicle seat according to claim 1,
wherein
the backrest frame and the seat part frame are each displaceable exclusively in translation.

5. The vehicle seat according to claim 4,
wherein
the backrest frame and the seat part frame can be displaced in translation by means of a guiding means, wherein preferably the guiding means can be at least one sliding block guide.

6. The vehicle seat according to claim 1,
wherein
the backrest frame and the connecting frame are connected to a first upholstery element and the seat part frame is connected to a second upholstery element, wherein preferably the first upholstery element is independent of the second upholstery element.

7. The vehicle seat according to claim 1,
wherein
there is a releasable connection between the seat part frame and the connecting frame, wherein the releasable connection preferably is a clip connection.

8. The vehicle seat according to claim 7,
wherein
the releasable connection comprises a sleeve element, which in a cross-section has a circular sector with a center angle of more than 180° and at most 300°, and a shaft piece formed at least partially complementary to the sleeve element and insertable into the sleeve element.

9. The vehicle seat according to claim 2,
wherein
a first variable angle is provided between the seat part frame and the connecting frame and a second variable angle is provided between the backrest frame and the connecting frame, wherein the size of the variable angles changes as the seat part frame is displaced, wherein the lumbar support is variable.

10. The vehicle seat according to claim 2,
wherein
the backrest frame and the seat part frame are each displaceable exclusively in translation.

11. The vehicle seat according to claim 3,
wherein
the backrest frame and the seat part frame are each displaceable exclusively in translation.

12. The vehicle seat according to claim 2,
wherein
the backrest frame and the connecting frame are connected to a first upholstery element and the seat part frame is connected to a second upholstery element, wherein preferably the first upholstery element is independent of the second upholstery element.

13. The vehicle seat according to claim 3,
wherein
the backrest frame and the connecting frame are connected to a first upholstery element and the seat part frame is connected to a second upholstery element, wherein preferably the first upholstery element is independent of the second upholstery element.

14. The vehicle seat according to claim 4,
wherein
the backrest frame and the connecting frame are connected to a first upholstery element and the seat part frame is connected to a second upholstery element, wherein preferably the first upholstery element is independent of the second upholstery element.

15. The vehicle seat according to claim 5,
wherein
the backrest frame and the connecting frame are connected to a first upholstery element and the seat part frame is connected to a second upholstery element, wherein preferably the first upholstery element is independent of the second upholstery element.

16. The vehicle seat according to claim 2,
wherein
there is a releasable connection between the seat part frame and the connecting frame, wherein the releasable connection preferably is a clip connection.

17. The vehicle seat according to claim 3,
wherein
there is a releasable connection between the seat part frame and the connecting frame, wherein the releasable connection preferably is a clip connection.

18. The vehicle seat according to claim 4,
wherein
there is a releasable connection between the seat part frame and the connecting frame, wherein the releasable connection preferably is a clip connection.

19. The vehicle seat according to claim 5,
wherein
there is a releasable connection between the seat part frame and the connecting frame, wherein the releasable connection preferably is a clip connection.

20. The vehicle seat according to claim 6,
wherein
there is a releasable connection between the seat part frame and the connecting frame, wherein the releasable connection preferably is a clip connection.
